(19) United States
(12) Patent Application Publication
(10) Pub. No.: US 2018/0108884 A1
(43) Pub. Date: Apr. 19, 2018

(54) BATTERY PACK

(71) Applicant: Tranmax Machinery Co., Ltd., Taichung City (TW)

(72) Inventor: Hsin-Chi CHEN, TAICHUNG CITY (TW)

(21) Appl. No.: 15/714,289

(22) Filed: Sep. 25, 2017

(30) Foreign Application Priority Data
Oct. 18, 2016 (DE) 202016105813.9

(51) Int. Cl. H01M 2/10

(52) U.S. Cl. CPC H01M 2/1055; H01M 2220/30

(57) ABSTRACT

A battery pack includes a battery case having an opening and a receptacle portion adjacent to the opening, a battery set mounted in the battery case, and a positioning device including a push button mounted in the battery case in a pressable manner, a positioning member pivotally mounted in the battery case and having a positioning block extending through the opening to the outside of the battery case and an engagement portion coupled with the push button and a return spring mounted between the receptacle portion of the battery case and the push button to impart an elastic restoring force to the push button. Thus, subject to the coupling relationship between the push button and the positioning member and the force of the return spring against the push button, the battery pack facilitates installation.

### BACKGROUND OF THE INVENTION

### 1. Field of the Invention

The present invention relates to power tool battery technology, and more particularly to a battery pack, which facilitates installation.

### 2. Description of the Related Art

DE 202007014418 U1 discloses a battery pack, which is characterized by the arrangement of a push button at the top cover of the battery case such that when the push button is pressed, a positioning member is forced to lower a positioning block thereof to the inside of the battery case, allowing the battery pack to be installed in a grip of a power hand tool. When released the pressure from the push button, the positioning member is forced by a torsion spring to move the push button back to its previous position,achieving positioning of the battery pack.

However, in the aforesaid prior art design, the battery pack lacks in a linking structure between the push button and the positioning member. Thus, during installation, the push button and the positioning member can be loosened and moved out of position, affecting subsequent operational stability. Thus, an improvement in this regard is necessary.

### SUMMARY OF THE INVENTION

The present invention has been accomplished under the circumstances in view. It is the main object of the present invention to provide a battery pack, which facilitates installation and enhances operational stability.

To achieve this and other objects of the present invention, a battery pack comprises a battery case, a battery set and a positioning device. The battery case comprises a top cover. The top cover comprises a top wall, a peripheral wall connected to the top wall, an opening cut through opposing top and bottom surfaces of the top wall, a receptacle portion located at the bottom surface of the top wall adjacent to the opening, and a button hole cut through the peripheral wall and aimed at the receptacle portion. The battery set is mounted in the battery case. The positioning device comprises a positioning member, a push button and a restoring spring. The positioning member is pivotally coupled to the top cover of the battery case, comprising an engagement portion and a positioning block. The positioning block extends through the opening of the top cover to the outside of the battery case. The push button is movably mounted in the button hole at the peripheral wall of the battery case, comprising a locating slot coupled with the engagement portion of the positioning member. The return spring is stopped between the receptacle portion of the top cover of the battery case and the push button, and adapted for imparting an elastic restoring force to the push button.

Subject to the coupling relationship between the push button and the positioning member and the force of the return spring against the push button, the battery pack, on the one hand, facilitates installation and prevents component dispersion, on the other hand, enhances operational stability, achieving the expected objects.

Other and further benefits, advantages and features of the present invention will be understood by reference to the following specification in conjunction with the accompanying drawings, in which like reference characters denote like elements of structure.

### BRIEF DESCRIPTION OF THE DRAWINGS

FIG. 1 is an oblique top elevational view of a battery pack in accordance with the present invention.

FIG. 2 is an exploded view of the battery pack in accordance with the present invention.

FIG. 3 is a bottom elevational view of the top cover of the battery case of the battery pack in accordance with the present invention.

FIG. 4 is a bottom elevational view of a part of the battery pack where the bottom cover and the battery set are excluded.

FIG. 5 is a sectional view of the battery pack, illustrating a non-pressing status of the push button.

FIG. 6 is similar to FIG. 5, illustrating a pressed status of the push button.

### DETAILED DESCRIPTION OF THE INVENTION

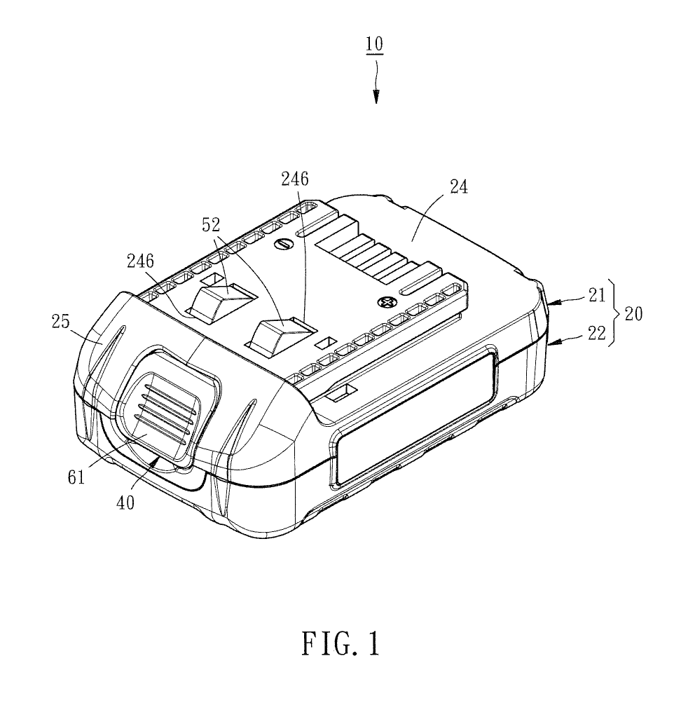

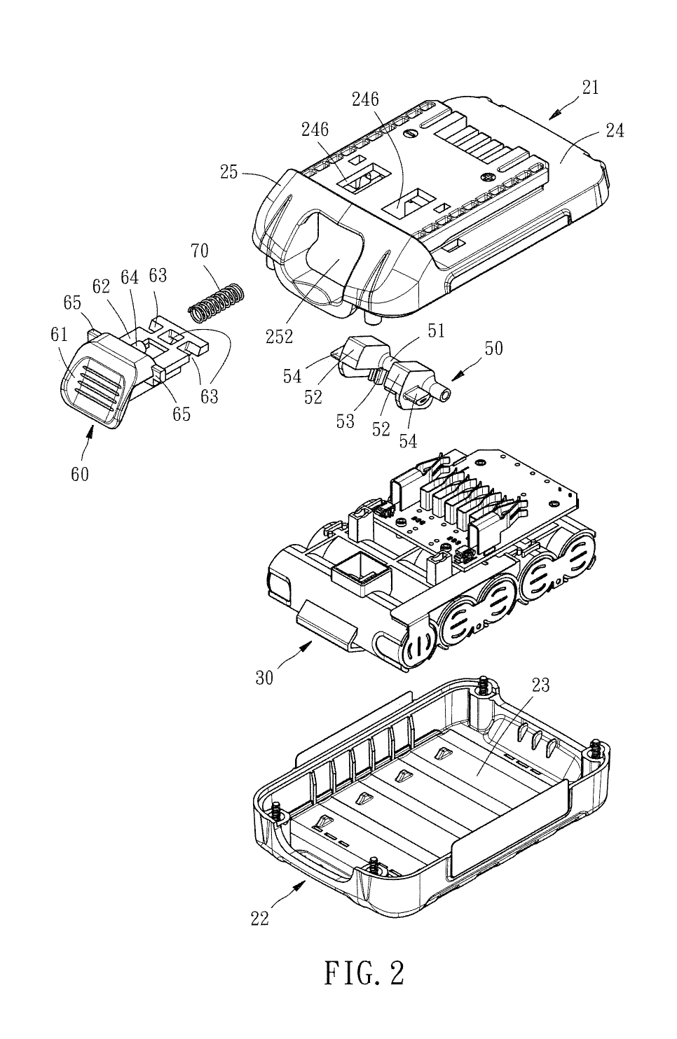

Referring to FIG. 1 and FIG. 2, a battery pack (10) in accordance with the present invention is shown. The battery pack (10) comprises a battery case (20), a battery set (30), and positioning device (40).

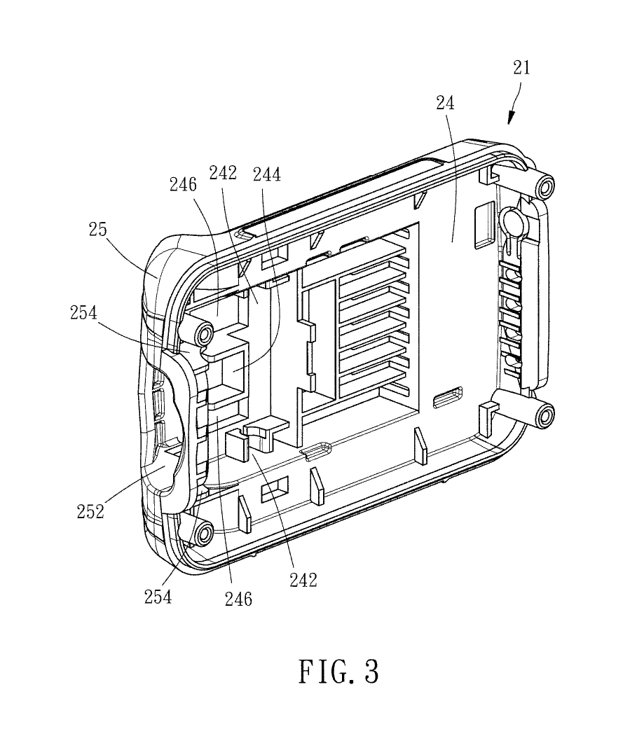

The battery case (20) comprises a top cover (21), and a bottom cover (22) fastened to the top cover (21). The bottom cover (22) defines therein a battery chamber (23). As illustrated in FIG. 3, the top cover (21) comprises a top wall (24), two opposing pivot-connection portions (242) located at a bottom side of the top wall (24), a receptacle portion (244) located at the bottom side of the top wall (24) between the two opposing pivot-connection portions (242), two openings (26) cut through the opposing top and bottom sides of the top wall (24) and respectively disposed between the two opposing pivot-connection portions (242) and two opposite lateral sides of the receptacle portion (244), a peripheral wall (25) connected to the top wall (24), a button hole (252) cut through the peripheral wall (25) and aimed at the receptacle portion (244), and two first stop blocks (254) located at an inner side of the peripheral wall (25) at two opposite sides of the button hole (252).

The battery set (30) is mounted in the battery chamber (23) of the bottom cover (22) of the battery case (20) for providing power source.

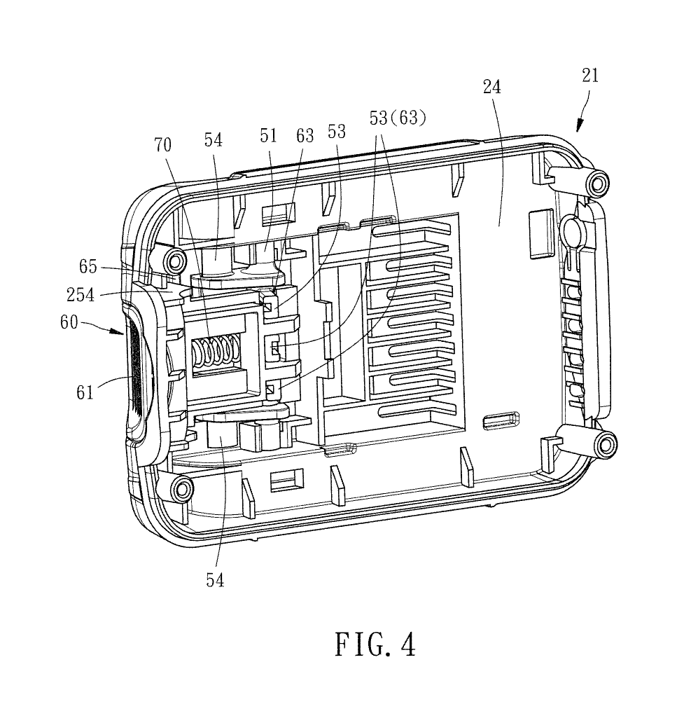

The positioning device (40) comprises a positioning member (50), a push button (60), and a restoring spring (70), as illustrated in FIGS. 2-4.

The positioning member (50) comprises a pivot axle (51), two opposing positioning blocks (52), and three engagement portions (53). The pivot axle (51) has two opposite ends thereof respectively and pivotally coupled to the pivot-connection portions (242) of the top cover (21) of the battery case (20). The positioning blocks (52) are extended from the pivot axle (51) at a top side and respectively inserted through the respective openings (246) of the top cover (21) to the outside of the battery case (20). The three engagement portions (53) are extended from the pivot axle (51) at an opposing bottom side and spaced from one another in a parallel manner. The positioning member (50) further comprises a position-limit protruding portion (54) outwardly extended from each positioning block (52) along the axial direction of the pivot axle (51). These position-limit protruding portions (54) are abutted against the bottom surface of the top cover (21) of the battery case (20) to stop the positioning member (50) in place, avoiding excessive pivoting.

The push button (60) comprises a press portion (61), and an extension portion (62) extended from the press portion (61) in direction toward the positioning member (50). The press portion (61) is disposed in the button hole (252) of the top cover (21) of the battery case (20). The push button (60) further comprises locating slots (63) arranged in parallel at a distal end of the extension portion (62) remote from the press portion (61) and respectively coupled to the engagement portions (53) of the positioning member (50), a positioning rod (64) extended from the press portion (61) toward the receptacle portion (244) of the top cover (21) of the battery case (20) above the extension portion (62), and two second stop clocks (65) respectively outwardly extended from two opposite lateral sides of the press portion (61) along the axial direction of the pivot axle (51) of the positioning member (50) and respectively abutted against the first stop blocks (254) of the top cover (21) of the battery case (20) to prohibit the push button (60) from falling out of the button hole (252) of the battery case (20).

Referring to FIG. 5 and FIGS. 2 and 4 again, the return spring (70) is sleeved onto the positioning rod (64) of the push button (60) and stopped with two opposite ends thereof against the receptacle portion (244) of the top cover (21) of the battery case (20) and the press portion (61) of the push button (60) for providing an elastic restoring force to the push button (60).

Thus, subject to the coupling relationship between the push button (60) and the positioning member (50), when pressed the push button (60), as shown in FIG. 6, the positioning member (50) is forced by the push button (60) to bias in direction away from the top wall (24) of the top cover (21) of the battery case (20). During the pivoting action of the positioning member (50), the positioning blocks (52) of the positioning member (50) are moved downwardly to the inside of the battery case (20), allowing the battery pack (10) to be attached to the grip of the power hand tool (not shown).

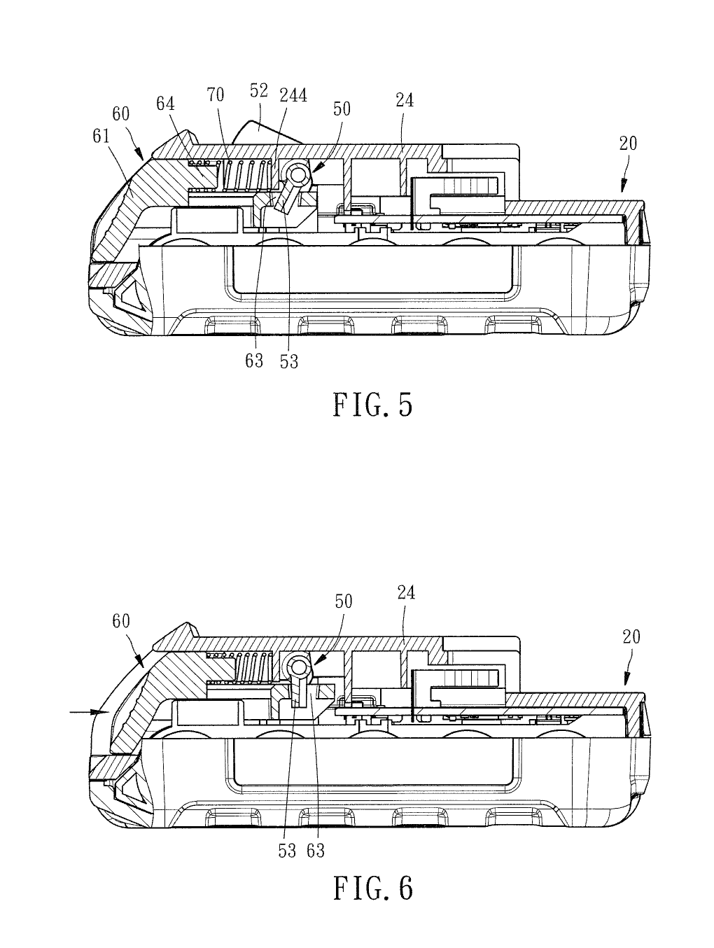

After installation of the battery pack (10) in the grip of the power hand tool, release the pressure from the push button (60), enabling the push button (60) to be pushed back to its previous position by the return spring (70), as shown in FIG. 5. Thus, the coupling relationship between the push button (60) and the positioning member (50) causes the positioning member (50) to be forced by the push button (60) to bias in direction toward the top wall (24) of the top cover (21) of the battery case (20) when the push button (60) is being moved back to its previous position. During the pivoting action of the positioning member (50), the positioning blocks (52) of the positioning member (50) are moved upwardly through the respective openings (246) of the top wall (24) to the outside of the battery case (20) into engagement with respective mating engagement portions (not shown) of the grip of the power hand tool to lock the battery pack (10) to the grip of the power hand tool. In case of power low, the user can push the push button (60) toward the inside of the battery case (20) to unlock the battery pack (10) from the grip of the power hand tool, allowing removal of the battery pack (10) from the power hand tool for recharging the battery set (30).

In conclusion, subject to the coupling relationship between the push button (60) and the positioning member (50) and the force of the return spring (70) against the push button (60), the battery pack (10) of the present invention, on the one hand, facilitates installation and prevents component dispersion, on the other hand, enhances operational stability, achieving the expected objects.

What is claimed is:

1. A battery pack, comprising:
a battery case comprising a top cover, said top cover comprising a top wall, a peripheral wall connected to said top wall, an opening cut through opposing top and bottom surfaces of said top wall, a receptacle portion located at the bottom surface of said top wall adjacent to said opening, and a button hole cut through said peripheral wall and aimed at said receptacle portion;
a battery set mounted in said battery case; and
a positioning device comprising a positioning member, a push button and a restoring spring, said positioning member being pivotally coupled to said top cover of said battery case and comprising an engagement portion and a positioning block, said positioning block being extended through said opening of said top cover to the outside of said battery case, said push button being movably mounted in said button hole at said peripheral wall of said battery case and comprising a locating slot coupled with said engagement portion of said positioning member, said return spring being stopped between said receptacle portion of said top cover of said battery case and said push button and adapted for imparting an elastic restoring force to said push button.

2. The battery pack as claimed in claim 1, wherein said battery case further comprising a bottom cover fastened to said top cover, said bottom cover defining therein a battery chamber adapted for accommodating said battery set.

3. The battery pack as claimed in claim 1, wherein said battery case further comprises two opposing pivot-connection portions located at the bottom surface of said top cover; said positioning member further comprises a pivot axle pivotally coupled with two opposite ends thereof to the respective said pivot-connection portions of said battery case; said positioning block and said engagement portion of said positioning member are respectively extended from opposing top and bottom sides of said pivot axle.

4. The battery pack as claimed in claim 3, wherein said positioning member further comprises a position-limit protruding portion outwardly extended from said positioning block along the axial direction of said pivot axle and abutted against the bottom surface of said top cover of said battery case.

5. The battery pack as claimed in claim 1, wherein said battery case further comprises a first stop block located at said peripheral wall of said top cover adjacent to said button hole ; said push button further comprises a press portion mounted in said button hole of said top cover, and a second stop clock outwardly extended from said press portion and abutted against said first stop blocks of said top cover of said battery case.
